(19) United States
(12) Patent Application Publication
(10) Pub. No.: US 2002/0169895 A1
(43) Pub. Date: Nov. 14, 2002

(54) Intelligent alerts

(76) Inventors: Rajiv Anand, Santa Clara, CA (US); Amitabh Sinha, Redwood City, CA (US)

Correspondence Address: PILLSBURY WINTHROP, LLP, P.O. BOX 10500, MCLEAN, VA, 22102, US

(21) Appl. No.: 09/765,079

(22) Filed: Jan. 17, 2001

(51) Int. Cl. G06F 9/46

(52) U.S. Cl. 709/313

(57) ABSTRACT

A method for allowing a user to respond efficiently to an alert. The method includes receiving at a communication device an alert including a pointer to a sequence of at least one operation to be performed at a first server, and responding to the alert by sending the pointer to the first server. The method then includes retrieving based on the pointer the sequence of at least one operation, and executing the sequence of at least one operation on behalf of the device.

### FIELD

This invention relates to obtaining a service using a communication device, and more specifically, to providing an alert that allows a user to respond to the alert in an efficient manner.

### BACKGROUND

Increasingly, wireless communications devices such as cellular phones, personal digital assistants, handheld computers provide or are going to be required to provide services such as stock trading, buying or selling goods, and getting sports or flight information, among other services. Some of these services may have as an aspect of the service the sending of an alert to a user of the service. For example, a user may request that the stock trading service send an alert when a certain stock changes by 10% in one day. A person flying on an airline may want the airline to send an alert when a flight is cancelled or delayed.

Some alerts may result in a user typically wanting to take some action. For example, a user who receives an alert that a stock has changed by 10% may want to engage in a buy or sell trade, or receive a quote for the latest stock price. A person who is notified that a flight was cancelled may want to rebook another flight. Presently, when one is notified of an alert and one wants to respond to the alert by contacting the website that provides the service associated with the alert, one has to engage in a laborious and time-consuming effort to get to the proper web page to engage in either of the aforementioned responses.

For example, a user may have to retrieve the home page of the trading service, go to a login page, go to the user's home page, and then finally go to the trading page. Having the user engage in all of these actions is a waste of both channel time and the user's time. Consequently, it is desirable to allow the user to respond to an alert in a relatively more efficiently manner, even though the user is responding by contacting a website that provides the service associated with the alert.

### SUMMARY

A method for allowing a user to respond efficiently to an alert is described. The method includes receiving at a communication device an alert including a pointer to a sequence of at least one operation to be performed at a first server, and responding to the alert by sending the pointer to the first server. The method then includes retrieving based on the pointer the sequence of at least one operation, and executing the sequence of at least one operation on behalf of the device.

### DESCRIPTION OF THE DRAWINGS

The present invention is illustrated by way of example, and not limitation, in the figures of the accompanying drawings in which like references denote similar elements, and in which:

FIG. 1 illustrates a block diagram of a system in which wireless and wired devices communicate with an application server;

FIG. 2 illustrates a process for generating an alert;

FIG. 3 illustrates a process for executing a command associated with an alert;

FIG. 4 illustrates a block diagram of a server that generates alerts; and

FIG. 5 illustrates a block diagram of a server that executes an alert command.

### DETAILED DESCRIPTION

Methods and apparatus for responding efficiently to an alert are described. In the following description, for purposes of explanation, numerous specific details are set forth in order to provide a thorough understanding of the present invention. It will be evident, however, to one skilled in the art that the present invention may be practiced in a variety of communication systems, especially wireless application protocol systems, and communications devices, especially telephones, without these specific details. In other instances, well-known operations, steps, functions and devices are not shown in order to avoid obscuring the invention.

Parts of the description will be presented using terminology commonly employed by those skilled in the art to convey the substance of their work to others skilled in the art, such protocol, gateway, render, store, interpret, and so forth. Also parts of the description will also be presented in terms of operations performed through the execution of programming instructions or initiating the functionality of some electrical component(s) or circuitry, using terms such as, performing, sending, processing, transmitting, configuring, and so on. As well understood by those skilled in the art, these operations take the form of electromagnetic, electrical, magnetic or optical signals capable of being stored, transmitted, transferred, combined, and otherwise manipulated through electrical or electromechanical components.

Various operations will be described as multiple discrete steps performed in turn in a manner that is most helpful in understanding the present invention. However, the order of description should not be construed as to imply that these operations are necessarily performed in the order that they are presented, or even order dependent. Lastly, repeated usage of the phrases “in one embodiment,” “an alternative embodiment,” or an “alternate embodiment” does not necessarily refer to the same embodiment, although it may.

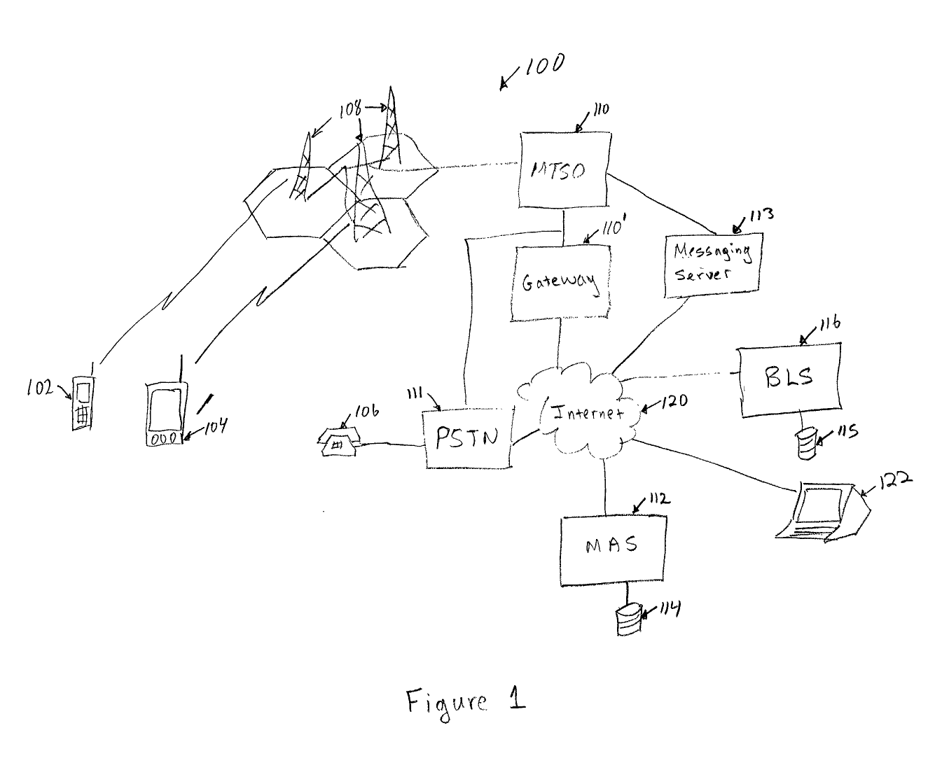

FIG. 1 illustrates a block diagram of a system in which wireless and wired devices communicate with an application server. System 100 includes telephone 102, personal digital assistant (PDA) 104, telephone 106, cellular stations 108, mobile telephone switching office 110, public switched telephone network switching office 111, mobile application server (MTSO) 112, storage 114, business logic server (BLS) 116, gateway 110′, internet 120, and computer 122. Business logic server 116 is the host for a website with an address or uniform resource locator that is widely known. It is not unusual for a popular website to have millions of users, if not tens of millions. For purposes of illustration, the website has the following address: www.services.com. The website provides in various embodiments services including, but not limited to, retrieving stock quotes and airline flight information or sport scores, trading stock, buying and selling goods. Since the services are provided using hypertext markup language (HTML) documents or pages, the website is referred to as a ‘full content’ website. These services can be procured directly from server 116 using computer 122 because computer 122 has sufficiently high processing power, a large display, and high communications data rate to support a web browser that is capable of executing HTML code.

Telephone 102 and PDA 104, on the other hand, typically have relatively low processing power, small displays, and a low communications data rate. Consequently, they are unable to support a browser that executes HTML code. In one embodiment, telephone 102 and PDA 104 have a browser that is capable of executing wireless markup language (WML) or handheld markup language (HDML) code, or any other language, which require relatively less processing power and communications data rate, and are better suited for the small displays of telephone 102 and PDA 104. Telephone 102 and PDA 104 are referred to herein as ‘reduced content’ devices because their browsers use WML and HDML to render less graphically intensive displays. WML and HDML are referred to herein as reduced content languages.

The remaining description below is provided in the context of telephone 102 procuring service. It should be appreciated that the description is equally applicable to PDA 104, a handheld computer, or other communications devices that have user input and output interfaces and the ability to communicate with a wireless network.

The nature of the services provided by the full content website are such that they are desired by mobile users of telephone 102. Moreover, the operator of the full content website would like to service mobile users without having to change significantly the full content website. Since the full content website is typically not going to be modified to specifically provide service to reduced content devices and since the full content website communicates in HTML code, a user of telephone 102 cannot directly access the services of the full content website.

However, a user of telephone 102 can indirectly access the services of the full content website by using a reduced content website on server 112. Server 112 hosts a reduced content website that can take HTML documents from server 116 and refonnat or represent them in a different manner so that they can be rendered on reduced content devices. For purposes of illustration, the reduced content website has the following address or URL: www.services.everypath.com. The reduced content website has a script for each page or document of the full content website. The script defines what is extracted from an HTML page and how it is to be presented on a reduced content device. Using the script, server 112 takes an HTML document and generates a page or pages in a language understood by a reduced content device. In one embodiment, server 112 generates WML or HDML documents that can be visually rendered at telephone 102. Alternatively, server 112 can generate audible voice information that can be heard using telephone 102. Mechanisms for extracting data from an HTML document and representing it in a manner suitable for reduced content devices is the subject of co-pending patent application “Method for Converting Two-dimensional Data into a Canonical Representation” with U.S. Ser. No. 09/394,120, filed on Sep. 10, 1999, and co-pending patent application “Method for Customizing and Rendering of Selected Data Fields” with Ser. No. 09/393,133, filed on Sep. 10, 1999.

For example, assume a user of telephone 102 desires to engage in a stock trade and that www.services.everypath provides a trading service. The user enters www.services.everypath into the telephone's browser which establishes contact with server 112 requests access to www.services.everypath.com—the details of establishing contact by way of stations 108, MTSO 110, and gateway 110′ will be described below. Server 112 recognizes from the request that telephone 102 is attempting to get to the home page of www.services.com which resides on server 116. Consequently, server 112 requests the home page from server 116. Using the script and the home page received from server 116, server 112 creates a reduced content page or pages that can be rendered by telephone 102. The reduced content pages are sent to telephone 102 by way of gateway 110′, MTSO 110, and cellular stations 108.

In one embodiment, the home page has fields for user identification and password that a user needs to fill in before submitting the page to server 112. The user can enter the information using the keypad (not shown) of telephone 102. After filling in the information requested by the home page, the user submits the page to server 112. Server 112 extracts the information filled in by the user and submits the information back to server 116. Server 116 replies back with a menu page, www.services.com/menu. Using a script associated with the menu and the menu page, server 112 generates a page in a language understood by the browser of telephone 102 and sends the generated page to telephone 102. The user then selects the trading link from the menu. Telephone 102 receives the trading page through substantially the same process just described in connection with retrieving the home page and the menu page. The user then enters the symbol of the stock, and quantity of shares to be bought or sold and posts the request. A WML or HDML confirmation page is then sent to telephone 102 from server 112 based on an HTML confirmation page retrieved from server 116.

In an alternative embodiment, the home, menu, trading, and confirmation pages are rendered through text-to-voice technology that presents audible choices to a user of telephone 102. A user responds to server 112 by pressing a key to generate a dual tone multi-frequency (DTMF) tone or speaking into the telephone's microphone.

In the manner described above, according to one embodiment, a user of a non-HTML communications device such as telephone 102 is able to procure the services of an HTML based website on server 116.

Besides providing the ability to engage in stock trades, www.services.com on server 116 generates alerts for the user of telephone 102. For example, www.services.com may generate an alert such as “Your portfolio is down.” It is possible that a user who receives such an alert may want to engage in a trade such as selling off certain shares of stock. It is undesirable to have the user respond to the alert by engaging in the three operations—retrieving home, menu, and trading pages—described above before being able to conduct a trade. The present invention provides a user of telephone 102 with a mechanism for responding to an alert in a more efficient manner.

Before describing the mechanism, the operation of system 100 will be described. In one embodiment, telephone 102 and PDA 104 communicate in accordance with wireless access protocol (WAP). WAP is an application environment and a group of protocols that define access of wireless devices to internet services. The application environment is uniform and does not depend on the underlying protocol for the communications air link. WAP is implemented or will be implemented on global system for mobile communications (GSM), interim standard (IS)-136, time-division multiple access (TDMA), personal communications service (PCS), and code division multiple access (CDMA), among other schemes. The present invention can be practiced with any application environment and communications protocols.

A WAP request from telephone 102 can be an hypertext protocol (HTTP) request including a URL such as http://www.services.everypath.com. Telephone 102 converts the text URL into a binary wireless session protocol (WSP) request. WSP is a protocol layer that defines efficient exchange of data between applications. Depending on the particular embodiment, the binary request is transmitted to cellular station 108 in accordance with one of the air link protocols indicated above. Station 108 forwards the binary request to MTSO 110. MTSO is the interface to the public switched telephone network for mobile phones making telephone calls to or receiving calls from telephones such as telephone 106. MTSO 110 directs internet traffic to and from gateway 110′ which is an interface between the wireless network and internet 120. Gateway 110′ converts the binary request to an HTTP request and sends the request to server 112 via internet 120.

As described above, server 112 recognizes that the request is for the login page at www.services.com. Thus, server 112 requests that server 116 send it the HTML document associated with the login page. Using a script associated with the login page, server 112 generates a text WML page (or pages) and sends it to gateway 110′. It should be appreciated that server 112 can generate a page in a language, other than WML, that is understood by the reduced content device, such as HDML. Gateway 110′ converts the text WML page into binary WML. Gateway 110′ sends the binary WML page using WSP protocol to MTSO 110 which forwards it to station 108. Station 108 transmits the binary WML page to telephone 102. Telephone 102 converts the binary WML page into a text WML page. The browser interprets or executes the text WML page to render a screen of information on the display of telephone 102

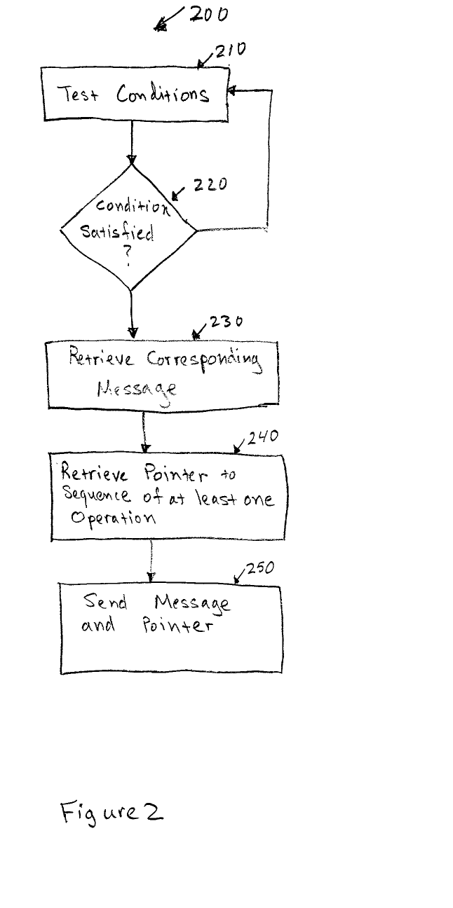

FIG. 2 illustrates a process for generating an alert according to one embodiment of the present invention. In process 200, server 116 tests 210 conditions that have been selected by users desiring alerts. For example, a user of a service provided by server 116 may select to have an alert generated when the user's portfolio decreases by a certain percentage. Another example of a condition for an alert may be cancellation of a user's flight.

Server 116 then determines 220 whether a condition has been satisfied. If a condition has not been satisfied server 116 returns to 210. If a condition has been satisfied server 116 generates an alert message to be sent to the user. To generate the alert message server 116 retrieves 230 a message associated with the condition. For example, a condition that is satisfied when a user's portfolio decreases by 10% may have the following corresponding message: “Your portfolio has decreased by 10%, would you like to trade.” Unlike the prior art which would only send a message along with a uniform resource locator to the home page of the website, server 116 includes 240 with the message a command that allows the user to respond efficiently to the alert. The command is an HTTP request to server 112 that the user can have sent to server 112 if the user wants to trade. As described in greater detail below, the command includes a macro instruction or pointer to a sequence of operations on server 112. Server 116 then composes the alert and sends 240 the alert to messaging server 113. The alert is a request to server 113 to send the message and the command to telephone 102.

The following is an example of an alert according to one embodiment of the present invention:

http://alert.everypath.com
POST/
application =etrade&user=John Haynes&phone=
408555000&Message=“Your portfolio
is down 10%. Do you want to trade?”
http://services.everypath.com/macroid=trade&user=
John Haynes&password=KB4AUY

The first HTTP request above is an instruction to the messaging server to send the message “Your portfolio is down 10%. Do you want to trade?” and the second HTTP request above to telephone 102. When telephone 102 receives the message the browser of telephone 102 displays the message on the screen of telephone 102. When the user indicates that the user would like to trade, for example by pressing a ‘YES’ key on the phone, the second HTTP request is sent to server 112.

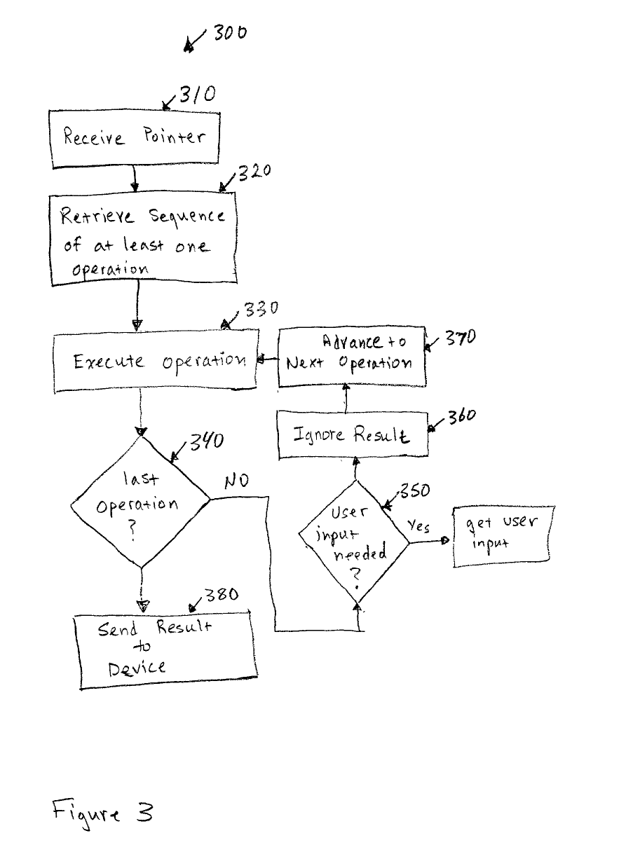

FIG. 3 illustrates a process for executing a command associated with an alert according to the present invention. In process 300, server 112 receives 310 the second HTTP request which includes a pointer (macroid) to a sequence of at least one instruction stored on server 112. The pointer has the name ‘trade.’ Server 112 then retrieves 320 the sequence of at least one operation that is associated with the macroid ‘trade.’

The following is an example of a sequence of operations for performing a trade:

| Macro | Trade |
|---|---|
| GET | opt=trading |
| POST | user=$(w)&password=$(x) |
| POST | action=trade |

The $() indicates that the name to the left of the ‘=’ symbol is a variable that needs to be defined. Since the second HTTP request included definitions for user and password, the definitions are substituted for $(w) and $(x), respectively when server 112 executes the operation.

Server 112 executes 330 the first operation of the macro instruction which is GET opt=trading. This operation retrieves the login screen from server 116. Server 112 then determines 340 whether there are any other operations left to perform. If there are no more operations left to perform, server 112 examines the result of the operation just executed and determines 350 whether input is desired from the user. The result of the GET op=trading operation is the login screen. Since the user supplied the user name and password, server 112 does not send 360 the login screen to telephone 102 and advances 370 to the next operation, the second operation, which is POST user$(w)&password$(x). The second operation is then executed 330. The second operation retrieves the menu page from server 116. If the user had not supplied the user identifier and password, server 112 would have sent 380 the login screen to telephone 102 and waited for the user to send back the user identifier and password before advancing to the next operation in the macro.

After the second operation is executed, server 112 determines whether any other operations are left to execute. Since there is one operation left, server 112 determines whether 350 whether input is desired from the user. Since the third operation defined that the trading link is to be selected from the menu page, server 112 does not send 360 the menu page to telephone 102 and advances 370 to the third operation. Server 112 then executes 330 the third operation, POST action=trade, to retrieve the trading screen from server 116. Since the third operation is the last operation, server 112 sends 390 the trading screen to telephone 102 in a language that telephone 102 understands.

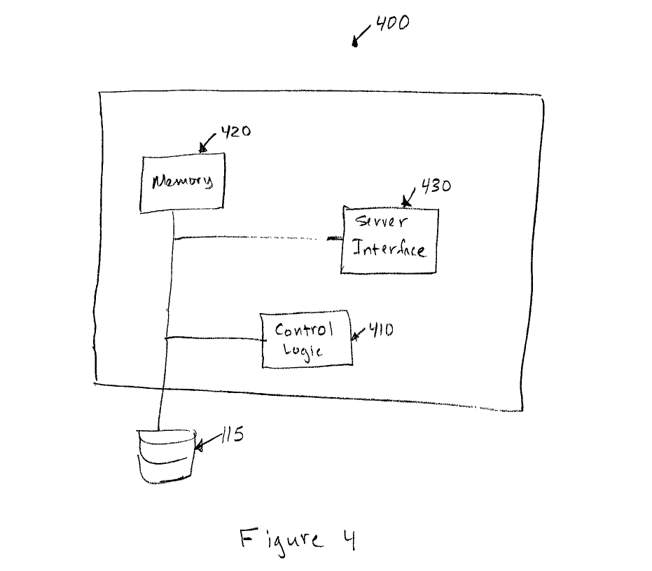

FIG. 4 illustrates a block diagram of a server that generates alerts according to one embodiment of the present invention. Server 400 is representative of server 116 of FIG. 1. In one embodiment, server 400 includes control logic 410. Control logic 410 tests conditions stored in memory 420. When a condition is satisfied, control logic 410 retrieves from storage 115 the message corresponding to the condition and the pointer or macro identifier or instruction associated with the message. Control logic 410 then composes an alert for telephone 102 using the message and the macro instruction. The macro instruction is included in a command that is sent in the alert. In one embodiment, the alert is a first HTTP request to messaging server 113 that includes within it a second HTTP request. The alert described above in connection with FIG. 2 is an example of an alert generated by control logic 410. The alert is sent to messaging server 113 using server interface 430. In the embodiment just described, server 400 operates in accordance with process 200 described above in connection with FIG. 2.

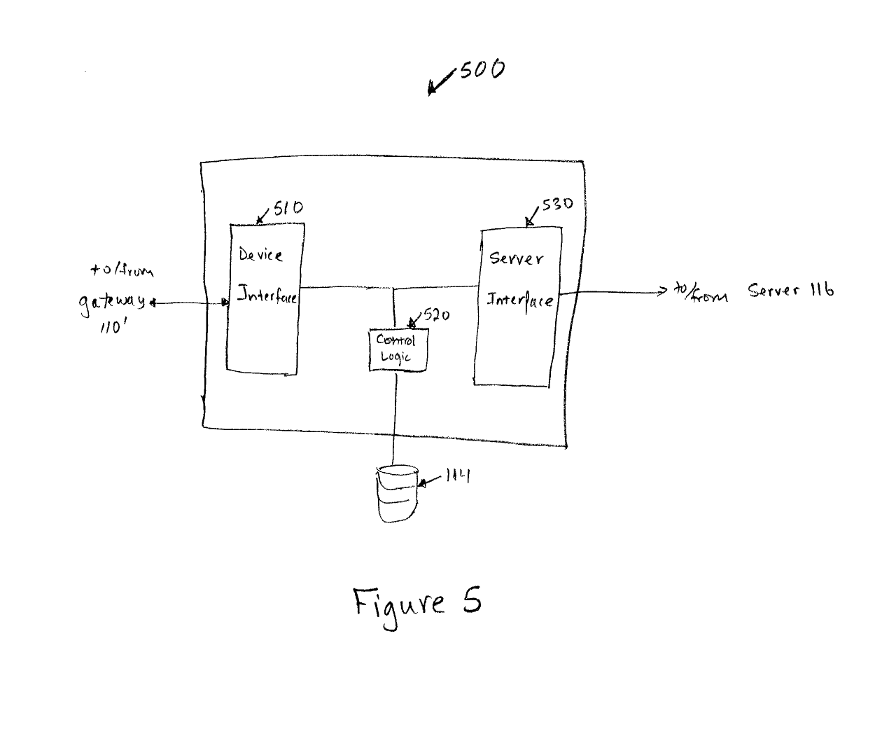

FIG. 5 illustrates a block diagram of a server that executes an alert command according to one embodiment of the present invention. Server 500 is representative of server 112 of FIG. 1. In one embodiment, server 500 includes device interface 510 that is to receive an HTTP request from gateway 110′. The HTTP request sent from gateway 110′ is based on a WAP request that gateway 110′ received from telephone 102. The second HTTP request, described above, is an example of an HTTP request that is received by server 112. When server 112 receives an HTTP request such as the second HTTP request, control logic 520 looks up in storage 114 the sequence of operations that correspond to the macro instruction received in the request. Control logic 520 then executes each of the operations in the sequence. The macro “Trade” defined above is an example of a sequence of operations that control logic 520 executes. According to one embodiment, control logic 520 engages in a transaction with server 116 for each of the operations it executes, using server interface 530. In alternative embodiment, control logic 112 does not need to engage in a transaction with another server to execute the operation. Control logic 112 sends the result of the last operation to telephone 102. The result of the last operation is a document in a language understood by telephone 102. In the embodiment just described, server 500 operates in accordance with process 300 described above in connection with FIG. 3.

Thus, methods and apparatus for responding efficiently to an alert have been described. Although the present invention has been described with reference to specific exemplary embodiments, it will be evident to one of ordinary skill in the art that various modifications and changes may be made to these embodiments without departing from the broader spirit and scope of the invention as set forth in the claims. Accordingly, the specification and drawings are to be regarded in an illustrative rather than a restrictive sense.

We claim:

1. A method for allowing a user to respond efficiently to an alert, the method comprising:
receiving at a communication device an alert including a pointer to a sequence of at least one operation to be performed at a first server;
responding to the alert by sending the pointer from the device to the first server;
retrieving, at the first server, based on the pointer, the sequence of at least one operation; and
executing at the first server the sequence of at least one operation on behalf of the device.

2. The method of claim 1, wherein executing the sequence occurs before receiving at the communication device.

3. The method of claim 1, further comprising sending a last result of executing a last operation in the sequence to the device.

4. The method of claim 1, wherein the sequence of at least one operation is a sequence of at least one HTTP request.

5. The method of claim 1, further comprising ignoring a result of executing each operation in the sequence of at least one operation except for a last result of a last operation in the sequence of at least one operation.

6. The method of claim 1, wherein ignoring includes sending to the device the last result of executing the last operation in the sequence of at least one operation.

7. The method of claim 1, wherein receiving includes receiving a message to a user of the device and a command associated with the message.

8. The method of claim 7, further comprising invoking the command based on input from the user.

9. A method for providing an alert, wherein the alert includes a command for responding to the alert, the method comprising:
determining whether a condition has been satisfied;
generating an alert including a command for responding to the alert;
sending the alert to a device;
wherein the command is a request from the device to the server to execute the sequence of at least one operation; and
wherein the request includes a pointer to a sequence of at least one operation to be executed by a server on behalf of the device.

10. The method of claim 9, wherein the sequence of at least one operation is a sequence of at least one HTTP request.

11. A method for allowing a user to respond efficiently to an alert using a communications device, the method comprising:
receiving from the device at a server a command including a pointer to a sequence of at least one operation;
wherein the command is part of an alert sent to the device;
executing the command by retrieving based on the pointer the sequence of at least one operation;
executing the sequence of at least one operation on behalf of the device; and
sending a result of executing the sequence to the device.

12. The method of claim 11, wherein the sequence of at least one operation is a sequence of at least one HTTP request.

13. The method of claim 11, further comprising discarding each result of executing the sequence except for a result due to executing a last operation in the sequence.

14. The method of claim 13, wherein sending includes sending the result due to executing a last operation in the sequence.

15. The method of claim 11, wherein executing the sequence includes engaging in an HTTP request with a second server for each operation in the sequence.

16. A server for generating an alert, the server comprising:
control logic that is to compose an alert including a command and a pointer to a sequence of at least one operation; and
a server interface that is to send the alert to a device.

17. The server of claim 16, wherein the control logic is to test at least one condition and is to compose the alert based on the at least one condition being satisfied.

18. The server of claim 17, wherein the control logic is to select a pointer based the at least one condition being satisfied.

19. The server of claim 16, wherein the command is an HTTP request.

20. A server that allows a user of a device to efficiently respond to an alert, the server comprising:
a device interface that is to receive from a device a command including a pointer to a sequence of at least one operation;
control logic that is to execute the command by retrieving the sequence and executing the sequence to produce a result for each operation in the sequence; and
wherein the control logic is to execute the sequence instead of having a device engage in an operation with the server for each operation in the sequence of at least one operation.

21. The server of claim 20, wherein the sequence of at least one operation is a sequence of at least one HTTP request.

22. The server of claim 21, wherein executing the sequence includes engaging in an HTTP request with a second server for each operation in the sequence of at least one operation.

23. The server of claim 20, wherein the control logic is to forward to the device only a last result of a last operation in the sequence

24. The server of claim 20, wherein the sequence includes at least two operations.
